(19) United States
(12) Patent Application Publication
(10) Pub. No.: US 2004/0221803 A1
(43) Pub. Date: Nov. 11, 2004

(54) Bottle contact coating apparatus and improved sponges for use therein

(76) Inventors: Heinz Gunther Eisen, Essen (DE); Leendert Hoekman, Goes (NL)

Correspondence Address: ATOFINA Chemicals, Inc., Patent Department, 26th Floor, 2000 Market Street, Philadelphia, PA, 19103-3222, US

(21) Appl. No.: 10/792,123

(22) Filed: Mar. 3, 2004

Related U.S. Application Data
(60) Provisional application No. 60/458,307, filed on Mar. 28, 2003.

(51) Int. Cl. B05D 1/28; B05C 11/00

(52) U.S. Cl. 118/264; 427/429

(57) ABSTRACT

An improved sponge applicator and an improved contact coating apparatus for coating with liquid the outside surface of containers such as glass or plastic bottles is provided. The improved sponge applicator comprises an open cell foam having at least one surface for contacting and applying liquid to the container, and at least one section having a sealed surface for retarding flow of liquid from the sponge through the sealed surface and at least one unsealed surface for contacting the container, the sponge having an internal porosity allowing for flow of liquid through the open cell structure of the sponge. A method of sealing surfaces of an open-cell foam is also provided comprising swelling the foam with liquid, expelling excess liquid from the sponge and applying a sealant to the surface of the foam while the foam is still in its swelled shape, and curing the sealant on the sponge. An improved contact coating apparatus for bottles is also provided comprising means for rotating a container to be coated, a sponge coating applicator having several sealed surfaces and at least one unsealed surface, means for contacting the container with an unsealed surface of the sponge coating applicator, and means for supplying coating liquid to the sponge coating applicator.

This application claims benefit, under U.S.C. §119(e) of U.S. provisional application 60/458,307, filed Mar. 28, 2003.

### FIELD OF THE INVENTION

Application of liquid to the outside surface of a bottle that is moving on a conveyor path usually at high speeds has been practiced commercially. The apparatus for applying a liquid coating are designed to either spray the liquid onto the bottle or designed for direction application (contact coating) through contacting the bottle with an applicator containing the liquid which results in transfer of liquid onto the bottle surface. Such apparatus for coating a liquid onto the surface of a bottle or container and are well known to those skilled in the art. One type of coating apparatus involving direct contact between the bottle and an applicator containing the liquid utilizes a foamed rubber sponge as the liquid containing applicator that touches the bottle. The present invention concerns an improved sponge design for applying liquid onto the surface of a container.

A machine for direct contact coating of bottles is usually equipped with a sponge that transfers the coating liquid to the bottles and a belt that drives the bottles along the sponge and rotates the bottle while contacting the sponge. The contact coating apparatus is placed over a conveyer belt that transports bottles usually in a plant that utilizes bottles in a manufacturing process such as a filling plant. The rotating belt and the usually static sponge of the coating machine form a coating lane through which the bottles must pass while being transported on the conveyor belt. The bottle rotates while contacting the sponge. While the bottle is revolving and simultaneously passing through the coating lane it takes the coating liquid off the sponge. Normally the sponge length is chosen to let the bottle revolve 3 times to ensure good coating properties. A direct contact coating machine can consist of one or several lanes, each having an applicator.

Most liquids being coated onto bottles by direct contact coating apparatus are water based solutions or emulsions. A foamed rubber sponge having a porosity suitable for applying the desired quantity of liquid coating depends on the viscosity of the liquid and the thickness of the desired coating. Examples of liquids being coated onto the surface of bottles are lubricating liquids designed to reduce friction and scratching of bottles when bottles contact each other. Another type of liquid applied to bottles is a liquid designed to mask or hide (camouflage) scratches on recycled bottles when the bottles are being refilled.

A typical sponge applicator and a portion of a contact coating apparatus is shown in FIG. 1.

Sponge (12) with feeding lances (22) of the apparatus is shown. The feeding lances supply coating liquid to the sponge. The one surface of the sponge contacts the bottle (10) The lances feed the coating liquid into the sponge. The lances have holes to be able to distribute the liquid into the sponge at all sections. In order to get a good distribution of the coating material in the sponge, at least 2 lances are used. The bottle rolls along the sponge and coating liquid is transferred to the bottle from the surface of the sponge that contacts the bottle. The sponge releases the coating liquid not only through the front or bottle contact side but also through it's other 5 surfaces where it is not desired. That waste coating material increasing the consumption dramatically. Although two lances are used the liquid is not distributed totally homogeneous inside the sponge. The liquid always has the tendency to flow down to the lower parts of the sponge thus feeding less into the upper section of the bottle.

The sponge is held within a frame or adequate box that lets only the front side of the sponge

### SUMMARY OF THE INVENTION

An improved sponge applicator and an improved contact coating apparatus for coating with liquid the outside surface of containers such as glass or plastic bottles is provided. The improved sponge applicator comprises an open cell foam having at least one surface for contacting and applying liquid to the container, and at least one section having a sealed surface for retarding flow of liquid from the sponge through the sealed surface and at least one unsealed surface for contacting the container, the sponge having an internal porosity allowing for flow of liquid through the open cell structure of the sponge. A method of sealing surfaces of an open-cell foam is also provided comprising swelling the foam with liquid, expelling excess liquid from the sponge and applying a sealant to the surface of the foam while the foam is still in its swelled shape, and curing the sealant on the sponge An improved contact coating apparatus for bottles is also provided comprising means for rotating a container to be coated, a sponge coating applicator having several sealed surfaces and at least one unsealed surface, means for contacting the container with an unsealed surface of the sponge coating applicator, and means for supplying coating liquid to the sponge coating applicator.

### BRIEF DESCRIPTION OF THE DRAWINGS

FIG. 1 depicts a prior art sponge (12) and a portion of a contact coating apparatus (24) with a bottle (10) being rotated in the direction shown by black arrow 25 while contacting the sponge.

FIGS. 2 through 5 depict different embodiments of an improved sponge (26) and a portion of an improved contact coating apparatus (28) with a bottle (10) being rotated while contacting the sponge.

### DETAILED DESCRIPTION OF THE INVENTION AND THE PREFERRED EMBODIMENTS

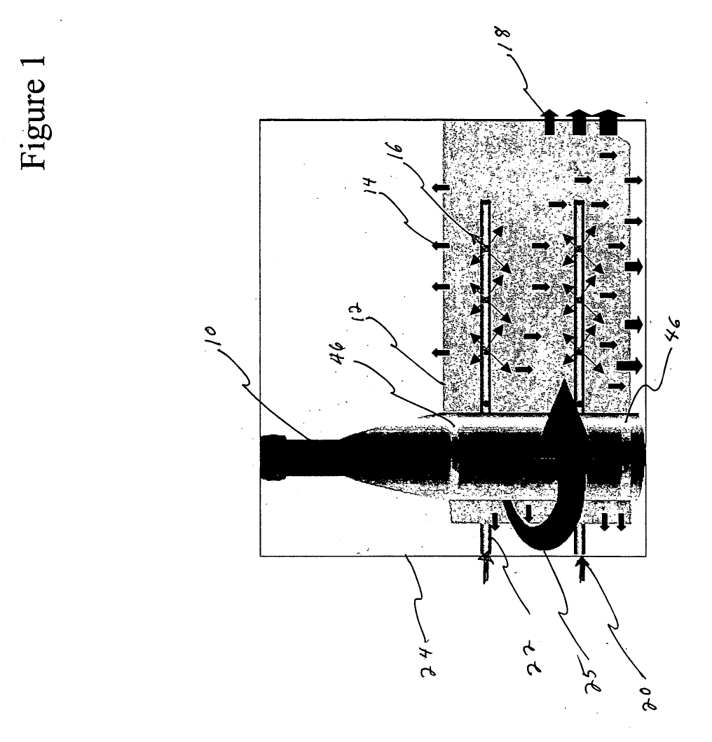

FIG. 1 depicts a prior art sponge (12) and a portion of a contact coating apparatus (24) with a bottle (10) being rotated in the direction shown by black arrow 25 while contacting the sponge. Lance portions (22) of the coating apparatus are shown with green arrows (20) depicting the feeding of coating liquid into the lances and into the sponge through holes (16) in the lances. Blue arrows (14) and (18) show the direction of liquid flow within and out of the sponge. The relative sizes of the blue and green arrows are proportional to liquid flow volumes. In the prior art embodiment shown in FIG. 1. Liquid is applied through the lances (green arrows) leaks out of the sponge, (Blue arrows)

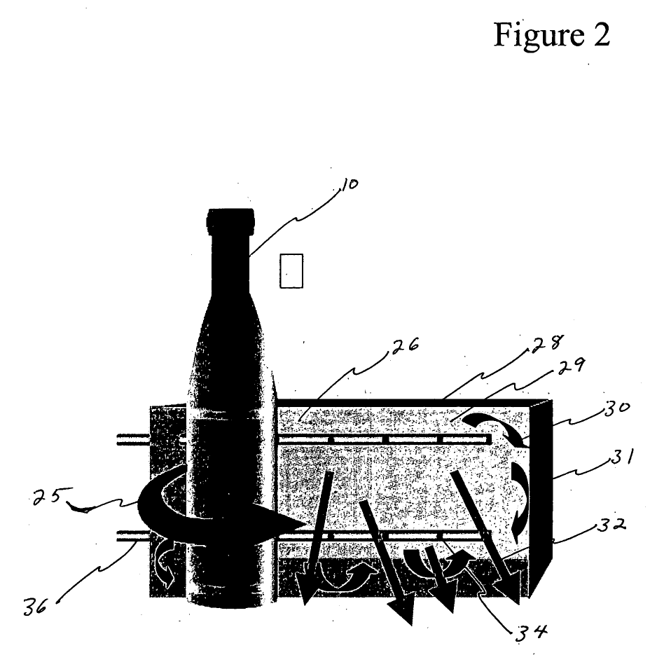

FIG. 2 depicts an improved sponge (26) and a portion of an improved contact coating apparatus (28) with a bottle (10) being rotated while contacting the sponge. Lance portions (36) of the coating apparatus are shown for feeding of coating liquid into the lances and into the sponge through holes (34) in the lances. Blue arrows (30) show the direction of liquid flow within the sponge being blocked from exiting the sponge through sealed surfaces 31 of sponge 26. The sealed surfaces are shown in black and brown. Liquid flows out of the sponge through surface 29 that contacts the bottle 10. The green arrows depict the flow of liquid through surface 29. The relative sizes of the blue and green arrows are proportional to liquid flow volumes. Liquid can not pass through the sealed surfaces 31 of the sponge (blue arrows), just through the front surface side 29, (green arrows) that contacts the bottle.

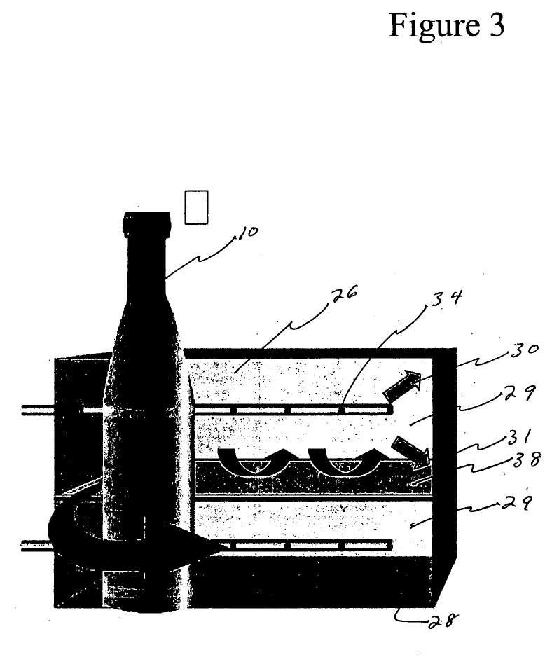

FIG. 3 depicts an improved sponge (26) and a portion of an improved contact coating apparatus (28) with a bottle (10) being rotated while contacting the sponge. Lance portions (36) of the coating apparatus are shown for feeding of coating liquid into the lances and into the sponge through holes (34) in the lances. Blue arrows (30) show the direction of liquid flow within the sponge being blocked from exiting the top section of the sponge through sealed internal surface 38 of sponge 26. The exterior sealed surfaces are shown in black and brown except for internal sealed surface, 38 which is shown in gray. Liquid flows out of the sponge through surface 29 that contacts the bottle 10. The green arrows depict the flow of liquid through surface 29. The relative sizes of the blue and green arrows are proportional to liquid flow volumes. The embodiment shown in FIG. 3 differs from the embodiment shown in FIG. 2 by the sponge 26 being divided onto two sections in FIG. 3 with separate feed lances into each sponge section. This allows for individual control of feed liquid into each sponge section and internal sealed surface 38 prevents liquid from the upper section of the sponge from migrating or flowing down to the lower section. The barrier sealing prevents the liquid from the upper portion of sponge 26 from flowing down. (Blue arrows) but is kept in the upper section of the sponge thus providing better control of liquid flow to each portion of the bottle (green arrows).

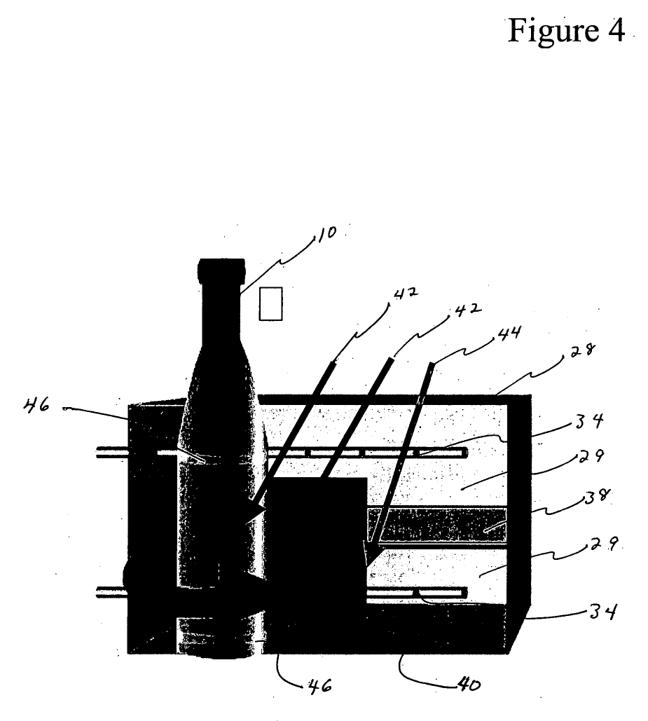

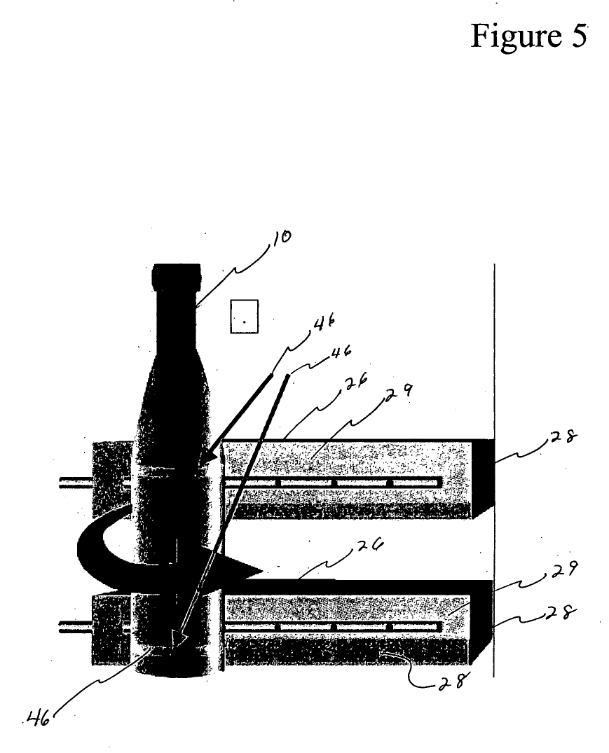

FIG. 4 depicts an improved sponge (26) and a portion of an improved contact coating apparatus (28) with a bottle (10) being rotated while contacting the sponge. Lance portions (36) of the coating apparatus are shown for feeding of coating liquid into the lances and into the sponge through holes (34) in the lances. The exterior and interior sealed surfaces are shown in black, brown and gray. The larger internal sealed section, 40 is shown in black. Sealed section 40 of sponge 26 is positioned to contact the bottle 10 in a region between ridges 46 of bottle 10. Ridges 46 are the portions of bottle 10 where ware and scratching tend to predominately occurred. By sealing section 46, liquid coating occurs predominately in the vicinity of ridges 46 where is mostly desired. Liquid flows out of the sponge through surface 29 that contacts bottle 10. The green arrows depict the flow of liquid through surface 29. The relative sizes of the blue and green arrows are proportional to liquid flow volumes. In the body zone the bottle will not be coated or only lightly coated in comparison to ridges 46 depending of the length of the sealed section 40 on surface 29. FIG. 5 depicts an improved contact coating apparatus (28) having two improved sponges (26) and with a bottle (10) being rotated while contacting both sponges. The points of contact between each sponge and bottle 10 is in the vicinity of ridges 46 that are shown in light gray and pointed to by green arrows. Each sponge in FIG. 5 is analogous to the sponge in FIG. 2 but one lance for each sponge in the embodiment depicted in FIG. 5 verses two lances in the sponge depicted in FIG. 2. The embodiment depicted in FIG. 5 is capable of applying different quantities of liquid to each ridge 46 or even different coating liquids to each ridge 46 of the bottle 10.

Sponge design. The preferred sponge design is shown in FIG. 3. The sponge should be an “open cell” type sponge which is a sponge having cells that not totally encapsulated but have open cell walls allowing the passage of liquid from one cell into an adjacent cell. The porosity of the sponge should be sufficient to permit flow sufficient liquid to coat the bottle at the desired coating thickness. The open cells are often referred to as pores. Sponges with pores sizes in the range of from 4 pores per linear centimeter of sponge to 20 pores per centimeter have adequate porosity for flow of liquid of the type typically used to coat bottles.

Sponge material: The material of construction for the sponge must be compatible with the liquid being applied. For organic based or water emulsions of organic coating chemicals, cellulosic sponges are preferred. Polyurethane is also suitable for many liquids and flexible (open cell) polyurethane foams are well known having various porosities. Reticulated foam, that is flexible, open celfoam having the cell wall removed by fire polishing of solvent extraction are also suitable and benefit from controlled porosity and more uniform flow of liquid through the foam sponge.

Sealing of sponge surfaces: A sealing material is applied to at least one side of the sponge. Preferably the sponge is a rectangular or square shape having 6 sides with 5 of the sides sealed and one unsealed side positioned in the contact coating apparatus to touch the portion of the bottle to be coated with the liquid. Preferably, the coating material is forced to leave the sponge only via the side of the sponge that contacts the bottle as depicted in FIGS. 2 through 5, which reduces the consumption of liquid dramatically. If the liquid to be applied to the bottle cause the sponge to swell or change shape verses the shape of a dry sponge, the sealing procedure for swellable sponges should be employed.

Sealing of surfaces of swellable sponges: A suitable method for sealing liquid swellable sponges on edges and back side is:

Make the sponge wet so that it can swell to maximum dimensions.

Throughly squese the sponge to remove excess liquid.

Prepare a sealant (preferred sealant for sealing a water containing coating liquid, the sponge sealant is mixture by adding 3 grams of Boscodur to 100 g of BV 57.

Apply the sealant formulation by using a brush. Stir well, apply material within 5 minutes.

Wait one hour, wet the sponge with a little bit of bottle coating liquid on the side(s) to be sealed again.

Repeat above two times more with a clean brush.

Sponge sealing material: The material for sealing the sponge is preferable commercially available sealants such as polyurethane resin in a suitable solvent (acetone CAS no 67-54-1, ethyl acetate CAS no 141-76-6 and methylethyl ketone CAS no 78-93-3) as sold under the trade name BV 57® by Bostik Findley GmbH which is a two part sealant system that requires the use of a hardner sold as Boscodur AF 8650 360 GR® by Bostik Findley GmbH.

Sponge dimensions: The dimensions for the sponge should be based upon the dimensions of the bottle to be coated. The height of the sponge as shown in FIGS. 2 and 3 should be slightly higher than the upper ridge of the bottle and the length of the sponge should be from one times the diameter of the bottle to about 8 times the diameter of the bottle being coated.

Utilization of the sponge and apparatus of the present invention. Application of liquid to the outside surface of a bottle is preferably performed on a bottle that is moving on a conveyor path usually at high speeds. The apparatus for applying a liquid coating of the present invention is designed for direction application (contact coating) through contacting the bottle with the sponge applicator of the present invention to which is fed the liquid to be coated onto the bottle by transfer of liquid onto the bottle surface. The apparatus of the present invention is usually equipped with a sponge that transfers the coating liquid to the bottles and a belt that drives the bottles along the sponge and rotates the bottle while contacting the sponge. The contact coating apparatus is placed over a conveyer belt that transports bottles preferably in a plant that utilizes bottles in a manufacturing process such as a filling plant. The rotating belt and the usually static sponge of the coating machine form a coating lane through which the bottles pass while being transported on the conveyor belt. The bottle rotates while contacting the sponge. While the bottle is revolving and simultaneously passing through the coating lane it takes the coating liquid off the sponge. Preferably the sponge length is chosen to let the bottle revolve 3 times to ensure good coating properties. Preferably the apparatus consists of several lanes, each lane having an applicator.

Preferred liquid for coating bottles utilizing the sponge and apparatus provided by the present invention is Opticoat™ series of cold end coatings sold by ATOFINA Chemical Company. Particularly preferred is Opticoat™ 140 which is a water based emulsion.

We claim:

1. An improved sponge applicator for coating a liquid onto the outside surface of containers comprising an open cell foam having a plurality of surface sections, at least one surface section designed to contact a portion of the container, at least one sealed surface for retarding flow of liquid from the sponge and wherein the sponge has an internal porosity allowing for flow of liquid through the open cell structure of the sponge.

2. The sponge of claim 1 having at least two unsealed surfaces for contacting the container with the sponge with one of the at least two unsealed surface sections designed to contact a different portion of the container than the other unsealed section and the at least one sealed surface retards flow of liquid from the sponge and wherein the sponge has an internal porosity allowing for flow of liquid through the open cell structure of the sponge

3. A method of sealing surfaces of a swellable open-cell foam comprising swelling the foam with liquid, expelling excess liquid and applying a sealant to the surface of the foam while the foam is still in its swelled shape.

4. An improved contact coating apparatus comprising a means for rotating a container to be coated, a sponge coating applicator having several sealed surfaces and at least one unsealed surface, means for contacting the container with an unsealed surface of the sponge coating applicator, and means for supplying coating liquid to the sponge coating applicator.

5. The improved apparatus of claim 4 having at least sponge coating applicators with one sponge coating applicators positioned to contact a bottle being coated by the apparatus at a different portion of the bottle than another sponge coating applicator.

6. The improved apparatus of claim 4 wherein said container is a glass or plastic bottle.

7. The improved apparatus of claim 4 wherein the sponge coating applicator comprises an open cell foam having a plurality of surface sections, at least one surface section designed to contact a portion of the container, at least one sealed surface for retarding flow of liquid from the sponge and wherein the sponge has an internal porosity allowing for flow of liquid through the open cell structure of the sponge.
